(19) United States
(12) Patent Application Publication
(10) Pub. No.: US 2006/0139757 A1
(43) Pub. Date: Jun. 29, 2006

(54) Anti-reflective coating for optical windows and elements

(76) Inventors: Michael D. Harris, Horseheads, NY (US); Christopher M. Lee, Corning, NY (US); Mike X. Ouyang, Painted Post, NY (US); Larry G. Mann, Painted Post, NY (US)

Correspondence Address: CORNING INCORPORATED, SP-TI-3-1, CORNING, NY, 14831, US

(21) Appl. No.: 11/261,172

(22) Filed: Oct. 28, 2005

Related U.S. Application Data
(60) Provisional application No. 60/640,729, filed on Dec. 29, 2004.

(51) Int. Cl. G02B 1/10

(52) U.S. Cl. 359/586; 359/580

(57) ABSTRACT

Generally, the invention is for a neutral color, anti-reflective coating for optical elements transmitting light in the visible range, said coating having a 3-layer or 4-layer structure comprising at least two coating materials selected from the group consisting of: (a) a coating material A having an index of refraction in the range of 1.35-1.5; (b) a coating material B having an index of refraction in the range of 1.9-2.4; and (c) a coating material C having an index of refraction in the range of 1.6-1.8. wherein said coating is placed on the first face or the second face, or both, of a substrate transmissive to light in the visible range. The invention is further directed to optical elements having the foregoing coatings.

### CLAIM OF PRIORITY

This application claims the benefit priority of U.S. Provisional Patent Application No. 60/640,729 filed Dec. 29, 2004 titled, “Anti-Reflective coating For Optical Windows and Elements,” and claims the benefit of priority under 35 U.S.C. 120.

### FIELD OF THE INVENTION

The invention is directed to anti-reflective coatings for use on optical elements such as lenses and windows. In particular, the invention is directed to anti-reflective coating that can be applied to the windows of digital mirror devices (“DMD”) containing digital light processing mirrors (“DLP”) used in digital projections systems.

### BACKGROUND OF THE INVENTION

The projection of images using digital light processing methods typically requires the use of a plurality or array of mirrors or micromirrors (see FIG. 1) to focus the light on a screen. As seen in FIG. 1, the array contains a plurality of mirrors that can be titled to selected angles. Some current examples of the devices that use these mirrors and arrays are rear projection televisions, front projection devices for use in business and cinematic environments, and for marquee displays. FIG. 2 is a picture of a typical Texas Instruments' Digital Micromirror Device (“DMD”) in which a plurality of mirrors is encased in a hermetically sealed housing 100 having a window 102 for the passage of light to and from the mirrors located therein.

FIG. 3 is a schematic of the principle elements of a typical DMD device 10 containing a plurality or array of mirrors. Not shown in FIG. 3 is the housing that surrounds the device illustrated in FIG. 2. The principle elements of the DMD are the array of mirrors 12, the chrome aperture 14 (gray-filled rectangles) and the window 16 overlying the aperture and mirror array. When the DMD is used in, for example, a projection system, incident light 22 (within the solid-line cone) from a light source 20 is focused at an angle, for example, an angle in the range of 10-30 degrees (10° to 30°) from the perpendicular to the plane window 16 overlying the mirror array. The incident light 22 passes through the window 16, strikes the mirrors of the array and is reflected by the individual mirrors. Each mirror in the array is capable of being titled at a selected angle determined by the manufacturer. When a mirror in the array is titled so that it is in the ON position, the light is reflected perpendicular to plane of the window as indicated by arrow 30 (within the dot/dash-line cone) toward a detector 40. When a mirror in array is tilted so that it is in the OFF position, the light is reflected through window 16 away from detector 40, for example in the direction as indicated by arrow 32 (within the dashed-line cone). In either ON or OFF position the light passes through window 16. The ratio of the intensity (“I”) between the ON and OFF positions is defined as the “contrast ratio” (“CR”), where CR=Iₒₙ/I_{off}.

As illustrated in FIG. 3, the DMD is illuminated with an f/3.0 cone of light. As illustrated, the incident illuminating white light is coming from a 100 watt tungsten lamp (or other lamp capable of producing white light) at an angle of 26° to the perpendicular of the window 16. The detector 40 collects light at an f/3.0 cone and is centered above the DMD as illustrated, normal to the window 16. The DMD operates in the Iₒₙ and I_{off} states. In the ON state, Iₒₙ is dominated by the DLP window's (16) normal transmission of reflected light from the ON state mirrors behind window 16 toward the detector. In the OFF state I_{off} is dominated by the residual reflectance from window 16 at 10°-30° incidence angle. Since I_{off} is a small value and anti-reflective coating (“ARC”) residual reflectance contributes a large amount to I_{off}, it is important that the ARC be designed so that I_{off} is minimized. In particular, one needs to design an ARC that has the lowest reflectivity at the selected incoming light incident angle with the lowest polarization dependence over a wide wavelength range. In the above example, one would wish to design an ARC which has the lowest reflectivity at 26° incident angle with the lowest polarization dependence at a wavelength range in 480-640 nm range. Minimizing I_{off} reflectance improves, for example, the contrast ratio.

While antireflective coating for windows of DMDs are known, little or no effort has been made to optimize the window 16 coating for angular operation. For example, 30 and -layer coating with quarter wavelength thickness are known. In view of the critical nature of anti-reflective coatings toward minimizing I_{off}, the development of optimized anti-reflective coating is important to the future development of DMDs and the systems that utilize them. Accordingly, the present invention describes optimized anti-reflective coatings for minimizing I_{off}.

### SUMMARY OF THE INVENTION

The present invention is directed toward antireflective coatings for use on the windows of digital mirror devices used in digital projection processes. The anti-reflective coatings of the invention can be used on either or both faces of the DMD window; preferably on both faces.

In one aspect the invention is directed to 3-layer anti-reflective coating for glass and glass ceramic windows of digital mirror devices used in digital projection processes, wherein the process utilizes light incident to the windows at and angle in the range of 0°-50°, preferable in the range of 10°-30°, and more preferably in the range of 20°-30°. The 3-layer coatings, including the glass or glass ceramic, are designated A/B/C/glass, where A is a low index of refraction (“n”) coating material having n in the range of 1.35-1.5; B is a high index of refraction (“n”) coating material having n in the ran 1.9-2.4; and
C is a medium index of refraction (“n”) coating materials having n in the range of 1.6-1.8. When the coating is applied to both faces of the glass the coated window may be referred to an A/B/C/glass/C/B/A window.

In another aspect the invention is directed to 4-layer anti-reflective coating for glass windows of digital mirror devices used in digital projection processes, wherein the process utilizes light incident to the windows at and angle in the range of 20°-30°. The 4-layer coatings, including the glass, are designated A/B/C/B/glass, where A is a low index of refraction (“n”) coating material having n in the range of 1.35-1.5; B is a high index of refraction (“n”) coating material having n in the range of 1.9-2.4; and C is a medium index of refraction (“n”) coating materials having n in the range of 1.6-1.8. When the coating is applied to both faces of the glass the coated window may be referred to an A/B/C/B/glass/B/C/B/A window.

In an addition aspect directed to 4-layer coatings, the coating layers, including the glass, can have the order A/B/A/B/glass when the glass is coated on one face and A/B/A/B/glass/B/A/B/A then both faces of the glass are coated.

In a further aspect the invention includes low index A coating materials selected from the group consisting of MgF₂ (n=1.38), and SiO₂ (n=1.46), and other coating materials known in the art that have an index of refraction in the range 1.5-1.6; high index B coating materials selected from the group consisting of Ta₂O₂ (n=2.0-2.2), TiO₂ (n=2.1-2.3), TiO₂:Pr (N=2.0-2.3), ZrO₂ (n=1.9-2.2), Nb₂O₃ (n=2.0-2.2) and other coating materials known in the art that have an index of refraction in the range 1.9-2.3; and medium index C coating materials selected from the group consisting of Al₂O₃ (N=1.62-1.68), Y₂O₃ (n=1.7-1.9) and other coating materials known in the art that have an index of refraction in the range 1.6-1.8.

### BRIEF DESCRIPTION OF THE DRAWINGS

FIG. 1 illustrates a mirror array as contained in a digital mirror device known in the art.

FIG. 2 is an external view of a commercially available digital mirror device (containing a plurality of tiltable mirrors) illustrating, among other features, the housing and window of the device.

FIG. 3A is a schematic side view of a digital mirror device illustrating selected features of the device and how light is incident on and reflected by the mirror array.

FIG. 3B illustrates a window 16 of FIG. 3A having a 3-layer coating.

FIG. 3C is a schematic side view of a digital mirror device, including the housing, illustrating the various elements of the device and their relationship to one another.

FIG. 4 illustrates the performance of an ion-beam assisted E-beam deposited 3-layer antireflective coating according to the invention.

FIG. 5 illustrates the reflectance of a 3-layer antireflective coating for 26° incident light.

FIG. 6 illustrates the angle dependence of the reflectivity of a 3-layer coating, the angles being in the range of 0°-60° in 10° increments.

FIG. 7A illustrates the angle dependence of the reflectivity of a 4-layer coating, the angles being in the range of 0°-60° in 10° increments.

FIG. 7B illustrates the reflectance at 12° and 30° of a preferred 4-layer coating using TaO₂.

FIG. 8 is a color figure illustrating the human eye sensitivity (luminous efficiency) to light wavelengths.

FIG. 9 illustrates the material dispersion of MgF₂, SiO₂, Al₂O₃, Ta₂O₅ and HfO₂ coating deposited by electron-beam deposition on a glass substrate.

FIG. 10 illustrates the reflectance curves at a 30° incident angle for eleven (11) anti-reflective coating depositions experiments,

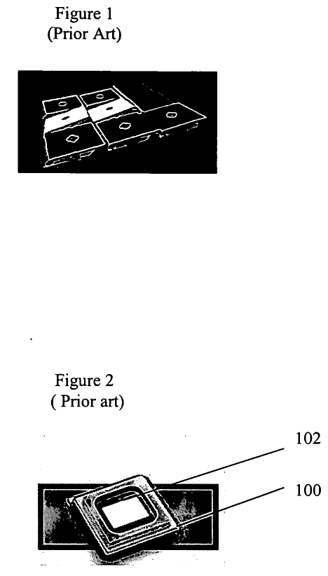

### DETAILED DESCRIPTION OF THE INVENTION

The coatings of the present invention can be used on any glass or glass-ceramic substrate or material that is transmissive to electromagnetic radiation in the visible light range; that is in all or part of the approximately 400-700 nm wavelength range. However, various reference texts list the visible light range as being from a low of 380 nm to a high of 780 nm. The invention described herein is applicable throughout the visible light range regardless as to whether it is defined as 380-780 nm or 400-700 nm.

As used herein, the term “glass” means both glasses and glass-ceramic materials that are transmissive to electromagnetic radiation in all or part of the visible light wavelength range. The selection of the glass or glass-ceramic material (including it transmissivity properties) that is used for the coating of the invention is a selection that will be made by the manufacturer of the device. The coatings of the invention are usable with all glass and glass-ceramic materials transmissive to visible light.

As the terms are used herein with reference to the “window” of the DMD, the term “first face” will refer to the face upon which the incident light from the light source first impinges the window and the terms “second face” will refer to the face from which the light exits the window and continues on to the tiltable mirrors of the device. From the view of the mirror array, light reflected by the mirror array initially strikes the window's second face and exits the window at the first face.

From theoretical studies of reflection and scatter coupled with anti-reflection coating reflections measurements and surface roughness measurements made on the glass substrates and coating, we have determined that reflectance is the primary source of I_{off} illumination. We have made correlation between reflection and contrast. As a result of our studies we have determined that using anti-reflective coating know in the art is not sufficient for DMD devices, and that it is necessary to design an anti-reflective coatings which have the lowest reflectivity at the light incident angles that are to be used, and that such coating should also have the lowest possible polarization dependence over a wide wavelength range. For DMD systems using visible light in the approximate 400-700 nm range, with the light being incident to the reflecting surface an angle in the range of 10°-30°, we have discovered selected 3-layer and 4-layer coatings that can be used to minimize reflectance in the visible light rang, for example, the approximate 400-700 nm range, and hence minimize I_{off}. The anti-reflective coating of the invention can be used in DMD systems such as high definition projection televisions sets, business and cinematic projectors for wide screens and similar projection systems know in the art, under development or developed in the future that uses the same technology.

Generally, the invention is for a neutral color, anti-reflective coating for optical elements transmitting light in the visible range, said coating having a 3-layer or 4-layer structure comprising at least two coating materials selected from the group consisting of:

(a) a coating material A having an index of refraction in the range of 1.35-1.5;

(b) a coating material B having an index of refraction in the range of 1.9-2.4; and

(c) a coating material C having an index of refraction in the range of 1.6-1.8.

wherein said coating is placed on the first face or the second face, or both, of a substrate transmissive to light in the visible range.

The invention is further directed to optical elements transmissive to light in the visible wavelength range, said elements comprising:

a substrate transmissive to light in the visible wavelength range, and

a coating on said substrate, said coating comprising at least two materials selected from the group consisting of:

(a) a coating material A having an index of refraction in the range of 1.35-1.5;

(b) a coating material B having an index of refraction in the range of 1.9-2.4; and

(c) a coating material C having an index of refraction in the range of 1.6-1.8.

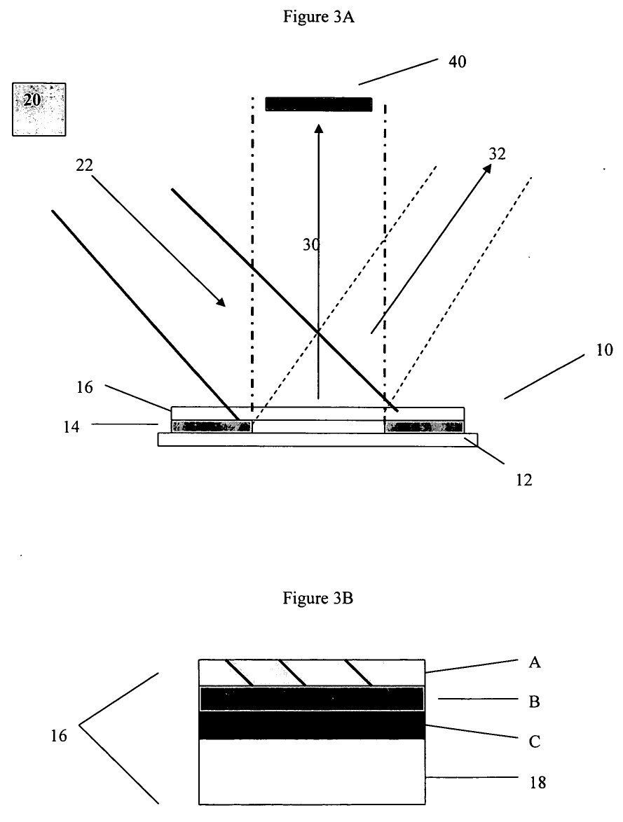

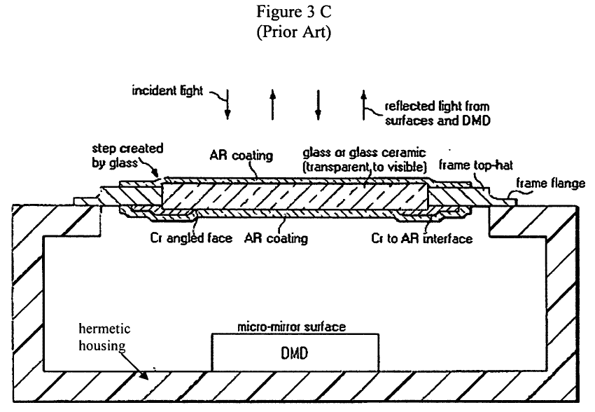

The invention is directed to 3- and 4-layer coatings that are placed on the windows of the DMD devices (element 16 in FIG. 3A) that transmit light in the visible wavelength range. The coating of the invention can also be used in conjunction with other optical elements whether they are in systems using DMD devices (for example, projectors and televisions) or systems that do not used such devices (for example, optical telescopes, camera, eyeglasses, etc.). The coatings of the invention are deposited on a substrate transmissive to light in the visible light range by any method known in the art for depositing coating materials as described herein on a substrate, including, but not limited to, sputtering by an electron beam (E-beam) (with or without ion-beam assist), ion sputtering, chemical vapor deposition (CVD), laser ablation, atomic layer deposition, and other methods known to those skilled in the art. The preferred methods are E-beam deposition and ion-assisted E-beam deposition.

The substrate for deposition of the coating of the invention can be any material transmissive to electromagnetic radiation in the visible light range. The preferred substrates are glass and glass-ceramics; for example, Corning 7056 glass, fused silica (fused SiO₂), Corning high purity fused silica (HPFS®), and other glass or glass-ceramic substrates known in the art that are transmissive to light in the visible range. Prior to deposition of the coating materials the surfaces of the glass substrate are polished and cleaned to remove traces of polishing agents, oils and other substances that may negatively impact the deposition of the coating materials. The coating materials may be applied to the first face, the second face, or both faces of the window. In preferred embodiments both faces of the substrate are coated with the anti-reflective materials of the invention.

The coating according to the invention may be either a 3-layer coating, described herein as an A/B/C coating or a 4-layer coating, described herein as an A/B/C/B or A/B/A/B coating. When the glass substrate is included, in the case of a 3-layer coating the coated glass substrate is described as an A/B/C/glass element or window when the coating is applied to one face of the glass or a A/B/C/glass/C/B/A element or window when the coating is applied to both faces of the glass. In the case of a 4-layer coating applied to one or both faces of a glass substrate, the coated element can be described as an A/B/C/B/glass, A/B/C/B/glass/B/C/B/A, A/B/A/B/glass or A/B/A/B/glass/B/A/B/A window or element, respectively. FIG. 3B illustrates an A/B/C/glass window 16 having a 3-layer coating A/B/C on one face of a glass substrate 18 in accordance with the invention. Deposition on both faces and the deposition of 4-layer coatings on the substrate 18 would be in the order indicated above.

In preferred embodiments of the invention, the 3-layer and 4-layer anti-reflective coatings of the invention are applied to both faces of the window. When the devices are in use, incident light enters the first face of the window, passes through the window and exits the window at the second face. The light then strikes the mirror and is reflected. The reflected light enters the second face of the window, passes through the window and exits the window at the first face. As a result there are four opportunities for reflectance to occur. Applying the anti-reflective coating of the invention to both the first and second faces of the window minimizes reflectance.

Coating material A is a low index of refraction (“n”) coating material having n in the range of 1.35-1.5. Coating material B is a high index of refraction coating material having n in the range of 1.9-2.4. Coating material C is a medium index of refraction coating materials having n in the range of 1.6-1.8. The low index A coating materials are selected from the group consisting of MgF₂ (n=1.47), BaF₂ (n=1.25) and SiO₂ (n=1.46), and other coating materials known in the art that have an index of refraction in the range 1.5-1.6. The high index B coating materials are selected from the group consisting of Ta₂O₂ (n=2.0-2.2), TiO₂ (n=2.1-2.3), TiO₂:Pr₂O₃ (n=2.0-2.3; where TiO₂:Pr₂O₃ can be either a mixture of TiO₂ and Pr₂O₃, or a mixed metal compound TiPrO₅), ZrO₂ (n=1.9-2.2), Nb₂O₃ (n=2.0-2.2), HfO₂ (ca. 1.95-2.2) and other coating materials known in the art that have an index of refraction in the range 1.9-2.3. The medium index C coating materials selected from the group consisting of Al₂O₃ (N=1.62-1.68), Y₂O₃ (n=1.7-1.9) and other coating materials known in the art that have an index of refraction in the range 1.6-1.8. Optionally, an additional thin protective micro-layer of Al₂O₃ or SiO₂ can be applied over coating material A when A is MgF₂ to protect the MgF₂ layer from reaction with any detrimental environmental elements. The protective micro-layer is applied at a thickness in the range of 3 to 50 nm.

The index of refraction of the coating materials will vary with the wavelength of the light being used. This is exemplified in the following Table 1 which is a non-exhaustive list some of the materials that can be used to prepare coating in accordance with the invention. As one can see from Table 1, the variation in refractive index for each material is small in the visible light range, exemplified in Table 1 as 400-700 nm.

TABLE 1
Refractive Index Dependence on Wavelength

| | Refractive index | | | | |
|---|---|---|---|---|---|
| Wavelength | MgF₂ | HfO₂ | SiO₂ | Ta₂O₅ | Al₂O₃ |
| 420 | 1.381 | 1.985 | 1.464 | 2.107 | 1.663 |
| 450 | 1.380 | 1.974 | 1.462 | 2.091 | 1.660 |
| 500 | 1.380 | 1.960 | 1.459 | 2.071 | 1.658 |
| 550 | 1.379 | 1.950 | 1.458 | 2.056 | 1.656 |
| 600 | 1.379 | 1.943 | 1.456 | 2.045 | 1.654 |
| 650 | 1.378 | 1.937 | 1.455 | 2.037 | 1.653 |
| 700 | 1.378 | 1.932 | 1.455 | 2.030 | 1.652 |

Note:
Extinction coefficient K = 0 for each of the materials

For systems when the light first incident at an angle in the range of 0°-30°, the coating materials according to the invention are each applied to a thickness in the range of 65-140 nm; except that when SiO₂ is used as a low index coating material the thickness of the SiO₂ layer can range from 30-140 nm, and when HfO₂ is used the thickness can be in the range of 10-140 nm. Preferably the high and low index coating materials A and B are applied to a thickness in the range of 90-140 nm (except that SiO₂ can range from 30-140 nm and HfO₂ can range from 10-140 nm) and the medium index coating material C is applied to a thickness in the range of 65-90 nm.

### EXAMPLE 1

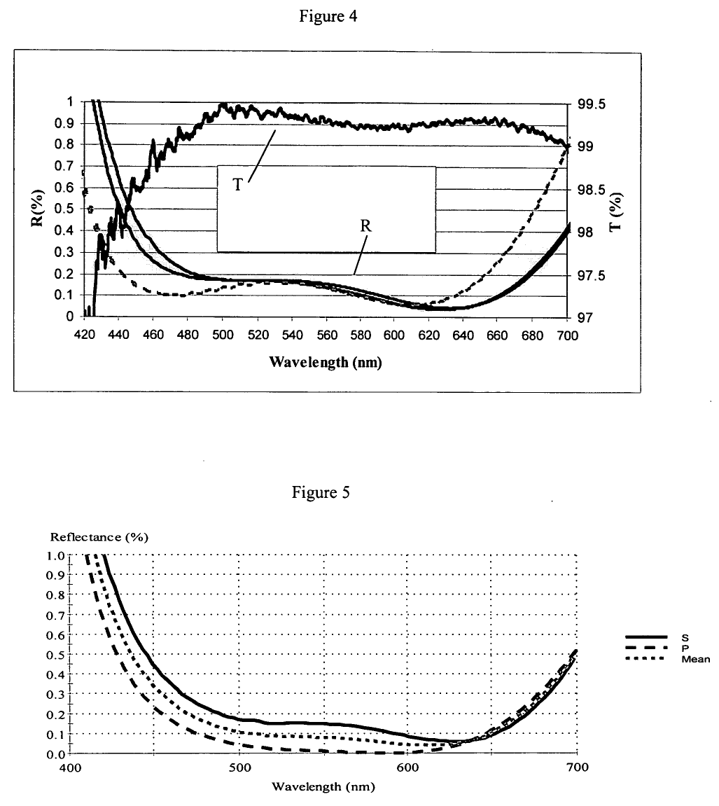

A polished and cleaned glass substrate of Corning 7056 glass was coated to form the coated A/B/C/glass window MgF₂ 101.5 nm)/Ta₂O₅ (121.8 nm)/Al₂O₂ (72.4 nm), the thickness of each layer being given in parenthesis. The coating was applied to the first face of the window. The optical performance of this coated window is shown in FIG. 4. The upper curve in FIG. 4 is the transmittance (“T”) and the lower group of curves is the reflectivity (“R”). The data was obtained using both 12° and 30° incident light.

The data in FIG. 4 indicates that the average measured reflectivity of less than 0.1 in the range 460-640 nm for both 12° and 30° light incident angle and that the average measured transmittance is greater than 99% in the wavelength range 420-720 nm. In addition, it has been determined that the sample of Example 1 has small perpendicular (“s”) and parallel (“p”) polarization separation performance over a wide range of incident light angles.

FIG. 5 is a simulation depicting the reflectivity of an Example 1 3-layer coating's polarization dependence. The sample of Example 1 also has reduced photonic performance variability due to reduced sensitivity to deposition process related variability; reduced complexity due to depositing fewer microlayers than the more traditional 4-layer anti-reflective coatings.

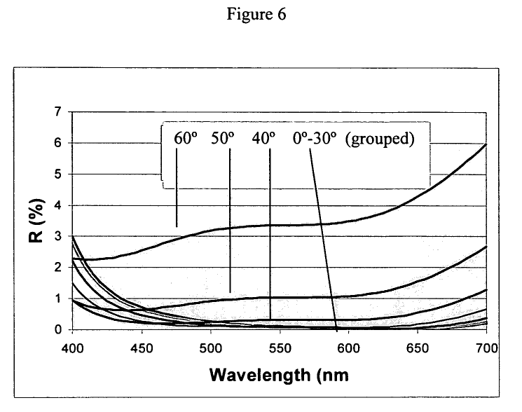

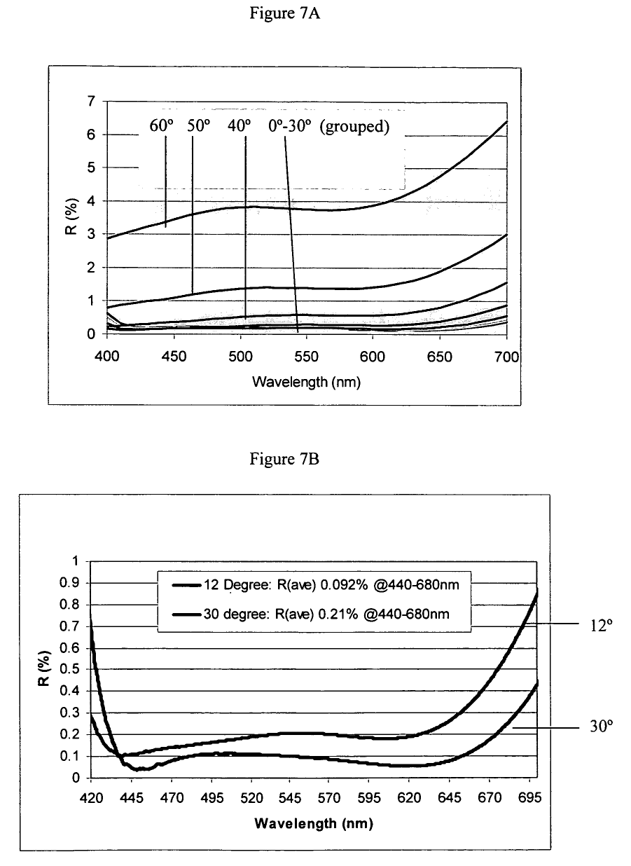

FIGS. 6, 7A and 7B illustrate the reflectivity of various 3-layer and 4-layer anti-reflective coatings of the invention. In FIGS. 6 and 7 the reflectance was measured for various angle dependencies in 10° increments in the range of 0°-60°. In FIG. 7B the reflectance was measured at 12° and 30° incident light angle. The 3-layer coating of the invention (FIG. 6) show less angular dependence and reflectivity between 0° and 40° in the wavelength range 440-660 nm than does the 4-layer coating of FIG. 7A. Although the 4-layer coating of FIG. 7A has a broader band width, it has slightly higher reflectivity and is slightly more sensitive to the incident angle than is the 3-layer coating of FIG. 6. FIG. 7B illustrates a preferred 4-layer coating using TaO₂ (n=2.0-2.2) as the high index material in place of HfO₂ as was used in FIG. 7A. However, both the 3-layer and 4-layer coatings of the invention are an improvement over the coatings in known in the art. Table 2 compares the optical loss of coated windows of the prior art (Samples A-G) versus a 3-layer window of the present invention. Optical loss is measured relative to a DMD without a window. Consequently the percent loss is indicative of the effect of placing a window on the DMD.

TABLE 2

| Sample | % Optical loss |
|---|---|
| A | 14.90 |
| B | 11.50 |
| C | 9.50 |
| D | 9.30 |
| E | 13.90 |
| F | 11.80 |
| G | 11.20 |
| 3-Layer of the invention | 2.20 |

When the date in Table 3 is view in combination with the data in FIGS. 6, 7A and 7B, it is clear that both the 3-layer and 4-layer anti-reflective coatings of the invention represent a significant improvement over the coating of the prior art.

The 3-layer reflective coating of the invention takes into consideration the human eye's sensitivity to colors utilizing the neutral color principle. The human eye contains rods and cones. The rods can perceive only black and white and are more sensitive to light intensity than they are to color. The cones are used to perceive color, and the human eye contains three types of color sensitive cones, one for each primary color-blue, green and red. By combining the light intensity received by each type of cone color is perceived. The sensitivity of the three types of cones to various wavelengths is termed “luminous efficiency”. Individual differences in visual sensitivity results in differences in color perception.

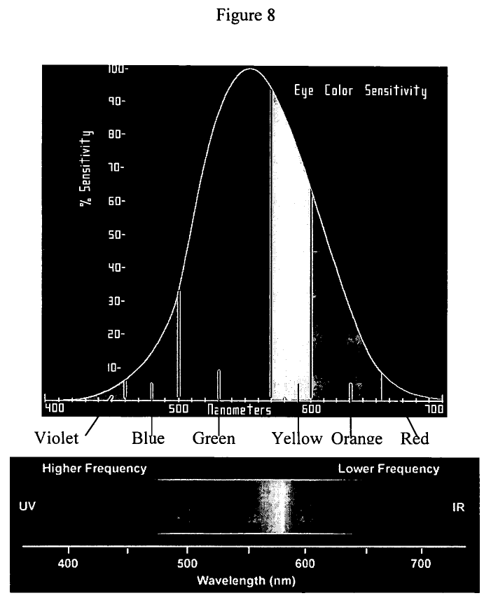

FIG. 8 illustrates the human eye's sensitivity to various light wavelengths. From FIG. 8 one can see that the human eye is very sensitive to light in the wavelength range of ˜520 nm to 600 nm. As a result of this sensitivity, the anti-reflection coatings of the present invention focus on low reflectivity at and beyond this range to avoid any color degradation due to residual window surface reflection. Because of the narrower band of the 3-three-layer anti-reflective coating versus the 4-layer coating structure, the 3-layer coating is less sensitive to micro-layer thickness. The 3-layer anti-reflective coatings disclosed herein provide less than 0.2% reflectivity at a wavelength band of in the range of 450 nm to 640 nm at 30° angle of incidence.

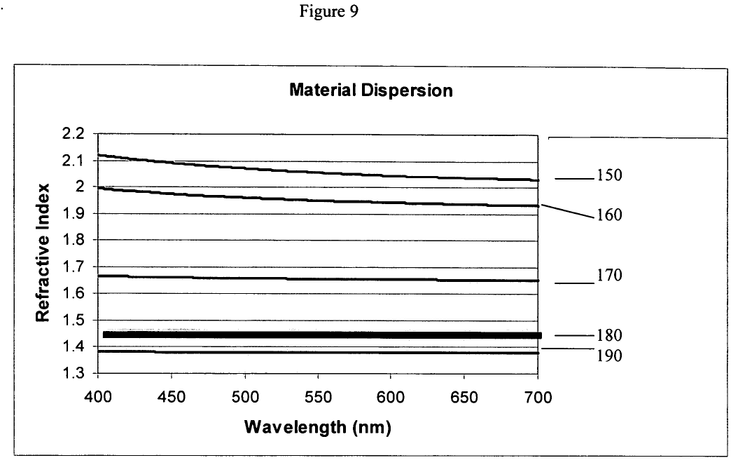

The coatings of the invention are deposited by methods known to those skilled in the art. The films so deposited are absorption free (extinction ratio k=0); and the thin film coat's dispersion, or wavelength dependence of refractive index, determines the spectral shape of reflectivity and transmission. FIG. 9, a graph of refractive index versus wavelength, illustrates that using the equipment and monitoring presently available one can control the dispersion of each layer of the coating very precisely. The result is high quality anti-reflective coating that can be repeated made from workpiece to workpiece.

Table 3 describes the coating 150-190 illustrates in FIG. 9.

Inventors: give the composition of the coatings from FIG. 9 (it was FIG. 8 in the Disclosure)

TABLE 3

| Sample | Composition |
|---|---|
| 150 | HfO₂ |
| 160 | Ta₂O₅ |
| 170 | Al₂O₃ |
| 180 | SiO₂ |
| 190 | MgF₂ |

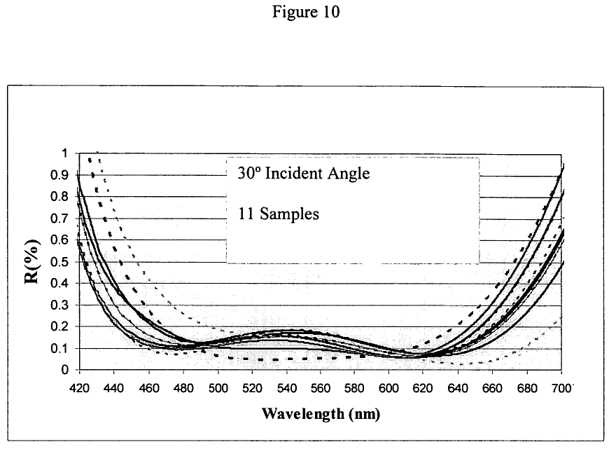

FIG. 10 summarizes the results from eleven (11) coating runs using the same coater. The reflectance curves shown in FIG. 10 are at a 30° incident angle. The data indicates that the repeatability of the coating procedure is very good and that the process is suitable fro production, even though the thickness control error was in the range of 2-4%. The optical loss for 3-layer windows prepared as described herein was in the range of 2-2.5% versus presently available coated windows that have a loss in the range of 9-15%.

The coatings of the invention, because of their low reflectance, have wide application and can be used in systems where the angle of incident light is in the range of 0° to 50°.

### EXAMPLE 2

A 3-layer coating on a glass substrate was prepared as follows.

TABLE 4

| | | Thickness | Refractive | Extinction |
|---|---|---|---|---|
| Layer | Material | (nm) | Index | Coefficient |
| 1 | MgF₂ | 100 | 1.38 | 0 |
| 2 | Ta₂O₃ | 120 | 2.07 | 0 |
| 3 | Al₂O₃ | 70 | 1.66 | 0 |
| Substrate | Corning 7056 | | 1.49 | 0 |

### EXAMPLE 3

A 4-layer coating on a glass substrate was prepared as follows (refractive index of each coating are process sensitive and may change +/−1-10%)

TABLE 5

| | | Thickness | Refractive | Extinction |
|---|---|---|---|---|
| Layer | Material | (nm) | Index | Coefficient |
| 1 | MgF₂ | 99 | 1.38 | 0 |
| 2 | HfO₂ | 134 | 1.96 | 0 |
| 3 | SiO₂ | 38 | 1.46 | 0 |
| 4 | HfO₂ | 13 | 1.96 | 0 |
| Substrate | Corning 7056 | | 1.49 | 0 |

By way of further illustration of the coatings of the invention, the contrast ratio was determined for:

A DMD device “without window”,

the same device with using number windows having prior art coatings, and

The device was tested using a 3-layer coating of the invention.

The results are tabulated in Table 6.

TABLE 6

| Sample | Contrast Ratio | Difference |
|---|---|---|
| Pre-Test Device w/o Window | 0.588 | Baseline |
| Window 1 | 0.555782333 | 0.001789 |
| Window 2 | 0.562995177 | −0/00284 |
| Window 3 | 0.565146831 | −0.00422 |
| Window 4 | 0.553547064 | −0.00323 |
| Window 5 | 0.56503298 | −0/00415 |
| Window 6 | 0.560957373 | −0.00153 |
| Window 7 | 0.552871609 | −0.003656 |
| Window 8 | 0.561626641 | −0.00197 |
| Post-Test Device w/o window | 0.589 | |
| Corning 3-layer window | 0.559746251 | −0.00075 |
| Corning 3-layer window* | 56.00% | −0.10% |

*The test indicates that the Corning 3-layer windows represent a 56% improvement over the coated windows of the prior art.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A neutral color, anti-reflective coating for optical elements transmitting light in the visible range, said coating having a 3-layer or 4-layer structure comprising at least two coating materials selected from the group consisting of:
(a) a coating material A having an index of refraction in the range of 1.35-1.5;
(b) a coating material B having an index of refraction in the range of 1.9-2.4; and
(c) a coating material C having an index of refraction in the range of 1.6-1.8.
wherein said coating is placed on the first face or the second face, or both, of a substrate transmissive to light in the visible range.

2. The coating according to claim 1, wherein when said coating is a 3-layer coating, the coating order is A/B/C/substrate when said coating is places on the first or second face of said substrate, and A/B/C/substrate/C/B/A when placed on both faces of said substrate.

3. The coating according to claim 1, wherein when said coating is a 4-layer coating, the coating order is A/B/C/B substrate or A/B/A/B/substrate when said coating is places on the first or second face of said substrate, and A/B/CB//substrate/B/C/B/A or A/B/A/B/substrate/B/A/B/A when placed of both faces of said substrate when placed on both faces.

4. The coating according to claim 1, wherein said substrate is selected from the group consisting of glass, glass-ceramics, fused silica and high purity fused silica transmissive to light in the visible range.

5. The coating according to claim 1, wherein coating material A is selected from the group consisting of MgF₂, SiO₂, BaF₂, and other materials known in the art to have an index of refraction in the range 1.35-1.5 and be transmissive to light in the visible range.

6. The coating according to claim 1, wherein coating material B is selected from the group consisting of Ta₂O₂, TiO₂, TiO₂:PrO₂ mixed oxide, TiO₂:ZrO₂ mixed oxide, ZrO₂, NbO₂, HfO₂ and other materials known in the art to have an index of refraction in the range 1.9-2.4 and be transmissive to light in the visible range.

7. The coating according to claim 1, wherein coating material C is selected from the group consisting of Al₂O₃, Y₂O₃ and other materials known in the art to have an index of refraction in the range 1.6-1.8 and be transmissive to light in the visible range.

8. The coating according to claim 1, wherein each coating material is applied to the substrate at a thickness in the range of 65-140 nm, except that when SiO₂ is used as a low index of refraction coating material the SiO₂ thickness can be in the range of 30-140 nm.

9. The coating according to claim 8, wherein the thickness of coating materials A and B is preferably in the range of 90-140 nm, except for SiO₂ whose thickness is in the range of 30-140 nm.

10. The coating according to claim 8, wherein the thickness of coating material C is in the range of 65-90 nm.

11. The coating according to claim 1, wherein the coating has a reflectivity of less than 0.2% at the wavelengths of 460 nm, 550 nm and 640 nm.

12. An optical element transmissive to light in the visible wavelength range, said element comprising:
a substrate transmissive to light in the visible wavelength range, and
a coating on said substrate, said coating comprising at least two materials selected from the group consisting of:
(a) a coating material A having an index of refraction in the range of 1.35-1.5;
(b) a coating material B having an index of refraction in the range of 1.9-2.4; and
(c) a coating material C having an index of refraction in the range of 1.6-1.8.
